(19) United States
(12) Patent Application Publication
(10) Pub. No.: US 2008/0300366 A1
(43) Pub. Date: Dec. 4, 2008

(54) Modified Fluoropolymer Composition and Modified Fluoropolymer Product

(76) Inventors: Yasuaki Yamamoto, Hitachi (JP); Etsuo Fukuchi, Takahagi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/132,645

(22) Filed: Jun. 4, 2008

(30) Foreign Application Priority Data
Jun. 4, 2007 (JP) 2007-148111

(51) Int. Cl. C08L 77/00

(52) U.S. Cl. 525/190

(57) ABSTRACT

A modified fluoropolymer composition according to the present invention is formed by mixing non-modified fluoropolymer, modified fluoropolymer, and polyamide in which a total amount of the modified fluoropolymer and the polyamide is 5 to 50 volume percent of a total amount of the non-modified fluoropolymer, the modified fluoropolymer, and the polyamide; and a volume ratio of the polyamide to the modified fluoropolymer is 0.1 to 2.

### CLAIM OF PRIORITY

The present application claims priority from Japanese patent application serial no. 2007-148111 filed on Jun. 4, 2007, the content of which is hereby incorporated by reference into this application.

### BACKGROUND OF THE INVENTION

1. Field of the Invention

The present invention relates to a modified fluoropolymer composition with superior resistance to heat, wear, and creep. Furthermore, the present invention relates to a modified fluoropolymer product made of the modified fluoropolymer composition, such as a sliding part, a sealing part, a packing, a gasket, a vessel for semiconductor manufacturing, a tool, or a pipe.

2. Description of Related Art

Conventional fluoropolymer (non-modified) compositions are less likely to wear out and contaminate and are superior in heat resistance, electric characteristics, and resistance to chemicals, and thus they are widely used in industrial and consumer applications. However, non-modified fluoropolymer largely suffers from wear and creep deformation when it is compressed at high temperature or under a condition in which the non-modified fluoropolymer is slid, making the non-modified fluoropolymer inapplicable in some applications. To address this problem, fillers have been added to the non-modified fluoropolymer to reduce wear and lessen creep deformation.

Highly elastic fillers are effective to give high wear resistance to the non-modified fluoropolymer composition. However, the resulting non-modified fluoropolymer composition poses some problems; for example, a member on which the non-modified fluoropolymer composition slides is damaged, and an increased friction coefficient is prone to generate more heat during sliding. Since the range of applications of the non-modified fluoropolymer composition is thus limited, the non-modified fluoropolymer composition has not been always satisfactory.

To address the above problems, a modified fluoropolymer is proposed which is formed by irradiating non-modified fluoropolymer with ionizing radiation under an atmosphere of low oxygen partial pressure at a temperature near the melting point of the non-modified fluoropolymer. The modified fluoropolymer is highly resistant to wear and creep and also is superior in intrinsic characteristics of a non-modified fluoropolymer. However, products made of this modified fluoropolymer have not always exhibited sufficient characteristics during sliding in a dry ambience or under high surface pressure in liquid (e.g., oil).

Documents related to the prior art concerning the modified fluoropolymer composition and modified fluoropolymer product according to the present invention are listed below.

JP-B-3608406 (U.S. Pat. No. 6,552,099);

JP-A Hei 9 (1997)-310281;

JP-B-367249;

JP-A Hei 7 (1995)-247377 (U.S. Pat. No. 5,555,549);

JP-A-2000-290409;

JP-A Hei 11 (1999)-172014; and

JP-A Hei 6 (1994)-32978.

### SUMMARY OF THE INVENTION

Under these circumstances, it is an object of the present invention to solve the above problems and to provide a modified fluoropolymer composition which exhibits high resistance to wear and creep and low friction characteristics in a dry ambience and oil. Furthermore, it is another objective of the present invention to provide a modified fluoropolymer product made of the modified fluoropolymer composition.

According to one aspect of the present invention, a modified fluoropolymer composition is formed by mixing non-modified fluoropolymer, modified fluoropolymer, and polyamide. A total amount of the modified fluoropolymer and the polyamide is 5 to 50 volume percent of a total amount of the non-modified fluoropolymer, the modified fluoropolymer, and the polyamide, and a volume ratio of the polyamide to the modified fluoropolymer is 0.1 to 2.

In the above aspect of the present invention, the following modifications and changes can be made.

(i) An amount of non-modified fluoropolymer is 50 to 95 volume percent, an amount of modified fluoropolymer is 3 to 30 volume percent, and an amount of polyamide is 2 to 25 volume percent.

(ii) The above polyamide is para-type or meta-type aromatic polyamide.

(iii) The above polyamide is particulate or fibrous.

(iv) A modified fluoropolymer product according to the present invention comprises the above modified fluoropolymer composition.

### ADVANTAGES OF THE INVENTION

The present invention can provide a modified fluoropolymer composition and a product made of the modified fluoropolymer composition which exhibit high resistance to wear and creep and low friction characteristics in a dry ambience and oil.

### DETAILED DESCRIPTION OF THE PREFERRED EMBODIMENTS

A modified fluoropolymer composition according to the present invention is formed by blending non-modified fluoropolymer, modified fluoropolymer, and polyamide.

Examples of non-modified fluoropolymer include polytetrafluoroethylene (PTFE), PTFE-fluoroalkoxytrifluethylene (PFA), and PTFE-hexafluoropropylene (FEP).

Some PTFEs (used as a first component) include polymer units based on copolymer monomers by 0.2 mol percent or less such as perfluoro (alkyl vinyl ether), hexafluoro propylene (perfluoro alkyl)ethylene or chlorotrifluoro ethylene, as a second component. These types of non-modified fluoropolymer may include a third component in their molecular structure by a small amount.

The modified fluoropolymer is generally obtained by, for example, heating non-modified fluoropolymer to its melting point or higher under an inert gas atmosphere in which an oxygen partial pressure is 10 torrs (1.3×10³ Pa) or less and then irradiating ionizing radiation to the non-modified fluoropolymer with a dose of 1 kGy to 10 MGy. Examples of ionizing radiation include gamma rays, electron beams, X-rays, neutron radiation, and high-energy ion beams.

The non-modified fluoropolymer needs to be heated to its crystal melting point or higher before the non-modified fluoropolymer is irradiated with electrolytic radiation. For example, when PTFE is used as the non-modified fluoropolymer, it needs to be irradiated at 327° C., which is the melting point of PTFE, or higher; when PFA is used, it needs to be irradiated at 310° C. or higher; when FEP is used, it needs to be irradiated at 275° C. or higher. When non-modified fluoropolymer is heated to its melting point or higher, molecular motion of main chains constituting the non-modified fluoropolymer is activated, and thereby it becomes possible to promote cross-link reaction among molecules efficiently. If, however, non-modified fluoropolymer is excessively heated, main molecular chains may be disconnected or decomposed, so non-modified fluoropolymer is preferably heated within a range of 10 to 30° C. higher than its melting point.

Conventional modified fluoropolymer manufactured in this way is superior in resistance to wear and creep. However, since a cross-link structure is formed in molecules, the electron density is uneven. As a result, the third fluorine comes off easily due to heat, and disconnection of molecular chains causes a drop in heat resistance.

After careful research and consideration based on the above problem by the inventors, it was found that, to increase heat resistance of modified fluoropolymer as described above, adding polyamide to the modified fluoropolymer was significantly effective, and thereby achieving the present invention. A detailed mechanism of this increase in heat resistance, which is caused by the addition of polyamide to the modified fluoropolymer, is not clarified yet, but it can be predicted that because the third fluorine which has come off due to heat is resupplied for stabilization, subsequent chain reactions that causes deterioration is stopped.

Preferable polyamide is para- or meta-type aromatic polyamide. Although ortho-type aromatic polyamide can also be used from the viewpoint of the structure, its synthesis is difficult and heat resistance during formation at constant temperature is insufficient. Furthermore, polyamide is preferably particulate or fibrous. The use of particulate or fibrous polyamide significantly improves sliding characteristics.

The total amount of modified fluoropolymer and polyamide mixed to form the modified fluoropolymer composition according to the present invention is 5 to 50 volume percent of the amount of modified fluoropolymer composition (the total amount of non-modified fluoropolymer, modified fluoropolymer, and polyamide). When the total amount of modified fluoropolymer and polyamide is less than 5 vol %, it is difficult to sufficiently increase the resistance to wear. When the total amount exceeds 50 vol %, a significant reduction in elongation is caused and thus the modified fluoropolymer composition becomes brittle mechanically.

A volume ratio of the polyamide to the modified fluoropolymer is 0.1 to 2. When the ratio of the polyamide to the modified fluoropolymer is less than 0.1, a improvement in wear resistance is not achieved sufficiently; when the ratio exceeds 2, the mechanical strength of the modified fluoropolymer composition is significantly reduced and the modified fluoropolymer composition becomes brittle. Moreover, the modified fluoropolymer composition is preferable when the volume ratio of the non-modified fluoropolymer is 50 to 95%; the volume ratio of the modified fluoropolymer is 3 to 30%; and the volume ratio of the polyamide is 2 to 25%.

As described above, the modified fluoropolymer composition in this embodiment is superior in resistance to heat, wear, and creep. In particular, the effect of the present invention is significant when the modified fluoropolymer composition is used in a dry ambience or oil. It is also possible to add a coloring agent, an antioxidant, a solid lubricant, or the like to the modified fluoropolymer composition in this embodiment.

A modified fluoropolymer product according to the present invention is formed by molding the modified fluoropolymer composition described above, and is superior in resistance to heat, wear, and creep. The modified fluoropolymer product can be used in many applications such as sliding parts in industrial machines and office automation devices as well as semiconductor manufacturing parts.

### EXAMPLES

Examples of the present invention will be described below with reference to Tables 1 and 2. However, the present invention is not limited to these examples described herein.

Specimens in Examples 1 to 7 and Comparative examples 1 to 8 were prepared and evaluated for (1) wear resistance test and (2) bending test. Tables 1 and 2 show results in Examples 1 to 7 and Comparative examples 1 to 8.

TABLE 1
Amount of mixed constituent is indicated in volume percent.

| | Examples | | | | Comparative examples | | | |
|---|---|---|---|---|---|---|---|---|
| Item | 1 | 2 | 3 | 4 | 1 | 2 | 3 | 4 |
| PTFE (P-63P) | 85 | 80 | 65 | | 80 | 80 | 80 | 80 |
| PFA (N-20) | | | | 70 | | | | |
| Modified PTFE | 10 | 10 | 30 | 10 | 20 | | | 10 |
| PTFE (KTL-20N) | | | | | | | 10 | |
| Aromatic polyamide*¹ | 5 | 10 | 5 | | | 20 | 10 | |
| Aromatic polyamide*² | | | | 20 | | | | |
| Glass fiber | | | | | | | | 10 |
| Sliding | | | | | | | | |
| characteristics | | | | | | | | |
| (dry) | | | | | | | | |
| Specific | 40 | 15 | 15 | 1200 | 30 | 180 | 7200 | 30 |
| wear rate | | | | | | | | |
| Friction | 0.25 | 0.26 | 0.25 | 0.58 | 0.26 | 0.25 | 0.25 | 0.28 |
| coefficient | | | | | | | | |
| Sliding | | | | | | | | |
| characteristics | | | | | | | | |
| (in oil) | | | | | | | | |
| Specific | 75 | 30 | 35 | 150 | 210 | 350 | 4500 | 290 |
| wear rate | | | | | | | | |
| Friction | 0.12 | 0.10 | 0.05 | 0.18 | 0.05 | 0.09 | 0.05 | 0.19 |
| coefficient | | | | | | | | |
| Bending test | Passed | Passed | Passed | Passed | Passed | Passed | Passed | Passed |

P-63P (available from Asahi Glass Co., Ltd.)
N-20 (available from Daikin Industries, Ltd.)
KTL-20N (available from Kitamura Limited; low molecular weight PTFE)
*¹TWARON (Registered trademark, available from Teijin Techno Products Limited; para-type: poly para phenylene terephthalamide)
*²CONEX (Registered trademark, available from Teijin Techno Products Limited; meta-type: poly meta phenylene isophthalamide)

TABLE 2
Amount of mixed constituent is indicated in volume percent.

| | Examples | | | Comparative examples | | | |
|---|---|---|---|---|---|---|---|
| Item | 5 | 6 | 7 | 5 | 6 | 7 | 8 |
| PTFE (P-63P) | 95 | 50 | 78 | 96 | 45 | 89.5 | 35 |
| PFA (N-20) | | | | | | | |
| Modified PTFE | 3 | 25 | 20 | 2 | 30 | 10 | 20 |
| PTFE (KTL-20N) | | | | | | | |
| Aromatic polyamide*¹ | 2 | 25 | 2 | 2 | 25 | 0.5 | 45 |
| Aromatic polyamide*² | | | | | | | |
| Glass fiber | | | | | | | |
| Sliding | | | | | | | |
| characteristics | | | | | | | |
| (dry) | | | | | | | |
| Specific | 860 | 10 | 35 | 1600 | 20 | 310 | 36 |
| wear rate | | | | | | | |
| Friction | 0.21 | 0.30 | 0.22 | 0.20 | 0.29 | 0.22 | 0.28 |
| coefficient | | | | | | | |
| Sliding | | | | | | | |
| characteristics | | | | | | | |
| (in oil) | | | | | | | |
| Specific | 1050 | 16 | 65 | 2300 | 41 | 1900 | 60 |
| wear rate | | | | | | | |
| Friction | 0.05 | 0.19 | 0.08 | 0.05 | 0.15 | 0.09 | 0.09 |
| coefficient | | | | | | | |
| Bending test | Passed | Passed | Passed | Passed | Failed | Passed | Failed |

P-63P (available from Asahi Glass Co., Ltd.)
N-20 (available from Daikin Industries, Ltd.)
KTL-20N (available from Kitamura Limited; low molecular weight PTFE)
*¹TWARON (Registered trademark, available from Teijin Techno Products Limited; para-type: poly para phenylene terephthalamide)
*²CONEX (Registered trademark, available from Teijin Techno Products Limited; meta-type: poly meta phenylene isophthalamide)

A method of preparing specimens in Examples 1 to 7 and Comparative examples 1 to 8 as well as tests for these specimens will be described below.

P-63P from Asahi Glass Co., Ltd. was used as non-modified PTFE; N-20 from Daikin Industries, Ltd. was used as PFA; and KTL-20N from Kitamura Limited was used as low molecular weight PTFE (non-modified). When PTFE was used, compounding agents were mixed by means of a mixer and hot forming was carried out. A mold with a diameter of 45 mm and a height of 80 mm was filled with powder and then heated at 360° C. for 1.5 hours, after which compression molding was carried out under a pressure of 50 MPa to form billets. The billets were cut to a thickness of 1 mm to obtain evaluation sheets. Aromatic polyamide included in the compounding agents was TWARON from Teijin Techno Products Limited (Registered trademark; para-type: poly para phenylene terephthalamide), which is fibrous.

When PFA was used, PFA and other compounding agents were mixed by means of a two-axis mixer, the diameter of the axis being 20 mm, at 340° C. and at a rotation rate of 20 rpm. The resulting mixture was then pressed by a hot press at 360° C. for 10 minutes under a pressure of 10 MPa to obtain evaluation sheets 1 mm in thickness. Aromatic polyamide included in the compounding agents was CONEX from Teijin Techno Products Limited (Registered trademark; meta-type: poly meta phenylene isophthalamide), which is fibrous.

To prepare modified PTFE, non-modified PTFE (P-63P) was illuminated with electron beams (for which an accelerated voltage of 1.5 MeV was used) by a dose of 120 kGy at a temperature of 340° C. under a nitrogen atmosphere in which the oxygen partial pressure was 10 Pa (10⁻⁵ mol/g).

A method of evaluating the specimens prepared in this way will be described below. Three measurements were performed for each type of specimen. Measured values were arithmetically averaged and the resulting value was used as the average.

(1) Wear Resistance Test

A thrust wear testing apparatus was used in wear resistance test. A test piece with an outer diameter of 25.6 mm, an inner diameter of 20.6 mm, and a thickness of 1 mm was pasted to a cylindrical ring, made of SUS304, with a diameter of 25.6 mm and an inner diameter of 20.6 mm, according to JIS K 7218. A SUS304 plate with a length of 30 mm, a width of 30 mm, a thickness of 5 mm, and an average surface roughness of 0.2 μm was used as the mating member.

To evaluate sliding characteristics in a dry ambience, a test was carried out under a pressure of 0.4 MPa at a peripheral speed of 2 m/s. A reduction in weight after 50 hours was measured and a specific wear rate (×10⁻⁸ mm³/Nm) was calculated. A friction coefficient was also obtained from a torque curve in a steady state.

Sliding characteristics in oil were evaluated as described below. A test piece with an outer diameter of 25.6 mm, an inner diameter of 20.6 mm, and a thickness of 2 mm was pasted to a mating plate, which is made of SUS304, with a length of 30 mm, a width of 30 mm, a thickness of 5 mm, and an average surface roughness of 0.6 μm. A test was carried out under a surface pressure of 3 MPa, and a peripheral speed of 0.5 m/s. Measurement time was 50 hours. The test piece was dipped in spindle oil (OMEGA613 from Magna Industrial Co., Limited) at an ordinary temperature. After the test, surface roughness was measured and a friction coefficient was calculated from the measured surface roughness. A torque curve was also used to obtain the friction coefficient.

(2) Bending Test

A sheet with a thickness of 1 mm, which is the same as the thickness of the above wear test piece, was left for one day at a temperature of 23° C., after which the test piece was bent by 180 degrees and then restored to the original state. This bending was repeated three times. A specimen that underwent neither a crack nor breakage after the test was logged as passed, and a specimen that underwent at least either a crack or breakage was logged as failed.

As indicated in Tables 1 and 2, in all of Examples 1 to 7 in the dry ambience and oil, the specific wear rate is low and wear resistance and low friction characteristics are superior. In the bending test, neither cracks nor breakages were found, indicating superior bending characteristics.

By comparison, in Comparative examples 1 and 2, in which both aromatic polyamide and modified PTFE were not used, wear resistance in oil was particularly low. In Comparative example 3, in which non-modified PTFE was used instead of modified PTFE, the specific wear rate was large in the dry ambience and oil, indicating that wear resistance was low. In Comparative example 4, in which glass fiber was used instead of aromatic polyamide, the specific wear rate was large and the friction coefficient was high in oil, indicating that sliding characteristics were poor.

In Comparative example 5, in which the total amount of modified PTFE and aromatic polyamide was less than 5 vol %, the wear resistance was low in the dry ambience and oil. In Comparative example 6, in which the total amount of modified PTFE and aromatic polyamide exceeds 50 vol %, cracks occurred in the bending test, indicating brittleness. In Comparative example 7, in which the volume ratio of aromatic polyamide to modified PTFE is less than 0.1, wear resistance was particularly low in oil. In Comparative example 8, in which the volume ratio of aromatic polyamide to modified PTFE exceeds 2, cracks occurred in the bending test, indicating brittleness.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. A modified fluoropolymer composition, wherein:
the modified fluoropolymer composition is formed by mixing non-modified fluoropolymer, modified fluoropolymer, and polyamide;
a total amount of the modified fluoropolymer and the polyamide is 5 to 50 volume percent of a total amount of the non-modified fluoropolymer, the modified fluoropolymer, and the polyamide; and
a volume ratio of the polyamide to the modified fluoropolymer is 0.1 to 2.

2. The modified fluoropolymer composition according to claim 1, wherein:
an amount of the non-modified fluoropolymer is 50 to 95 volume percent;
an amount of the modified fluoropolymer is 3 to 30 volume percent; and
an amount of the polyamide is 2 to 25 volume percent.

3. The modified fluoropolymer composition according to claim 1, wherein:
the polyamide is para-type or meta-type aromatic polyamide.

4. The modified fluoropolymer composition according to claim 1, wherein:
the polyamide is particulate or fibrous.

5. A modified fluoropolymer product, comprising: the modified fluoropolymer composition according to claim 1.
